(19) United States
(12) Patent Application Publication
(10) Pub. No.: US 2005/0102153 A1
(43) Pub. Date: May 12, 2005

(54) System and method for management of data requests in a regulatory proceeding

(76) Inventors: Yavuz Arik, Potomac, MD (US); Paul Raab, Bethesda, MD (US); Osman Kerem Tuzemen, Washington, DC (US)

Correspondence Address: ROBERTS ABOKHAIR & MARDULA, SUITE 1000, 11800 SUNRISE VALLEY DRIVE, RESTON, VA, 20191, US

(21) Appl. No.: 10/703,907

(22) Filed: Nov. 7, 2003

(51) Int. Cl. G06F 17/60

(52) U.S. Cl. 705/1

(57) ABSTRACT

A system and method for management of data requests in a regulatory proceeding. Document requests received by a regulated entity are managed over an electronic network. A proffered response is obtained from a company user and approval of the proffered response is obtained from each of one or more approvers. The approved proffered response is provided to a party from which the data request was received. In one embodiment of the present invention, obtaining a proffered response to a data request comprises selecting a data request for response, designating a company user to proffer a response to the selected data request, and obtaining from the selected company user the proffered response to the selected data request. In an embodiment of the present invention, obtaining approval of the proffered response from each of one or more approvers comprises assigning the proffered response to one or more departments for approval. Alternatively, the proffered response may be assigned to one or more company approvers. The proffered response is submitted to an approval pool. One of the one or more approvers is permitted to check-out the proffered response from the approval pool for review. In the event the reviewing approver approves the proffered response, the proffered response is returned to the approval pool. The process also comprises determining whether all of the one or more approvers have approved the proffered response. In the event that any of the one or more approvers have not approved the proffered response, a different one of the one or more approvers is permitted to check-out the proffered response from the approval pool for review. The process continues until all of the approvers have approved the proffered response. In the event that any one of the one or more approvers objects to the proffered response, the proffered response is returned to an Administrator.

### BACKGROUND

This invention relates generally to the field of regulatory affairs management. More particularly the present invention provides regulated entities involved in regulatory proceedings means for managing data requests.

In the last decade, many formerly regulated industries have been fully or partially deregulated. However, the reality remains that most critical utilities are provided by regulated entities that must deal with state and/or federal processes in order to manage their regulated businesses.

By way of illustration, the production, distribution, and sale of energy are highly regulated markets. The Federal Energy Regulatory Commission (FERC) is responsible for regulating the interstate transmission of natural gas, oil, and electricity. FERC regulates the wholesale sales of electricity and oil while the states regulate retail sales. FERC also licenses and inspects hydroelectric projects and approves the construction of interstate natural gas pipelines, storage facilities, and liquefied natural gas terminals.

For a regulated entity, many classic business decisions must be approved by a regulatory agency after a public hearing. The public hearing process requires that a regulated entity manage procedural requirements that include preparing responses to data requestsand questions. For example, in a rate case, a regulated entity files a request with a regulatory agency with oversight authority. This filing begins the rate case process. A hearing before an administrative law judge is held in which parties to the rate case may be represented by counsel, present evidence, question witnesses, and/or offer testimony. The basic issues of a utility pricing case include whether the rate increase should be granted and, if granted, how much of an increase is justified, which group of its customers (that is, residential, commercial, or industrial) should pay for rate increase and in what proportion.

Party status is not limited to the regulatory agency and a regulated entity. While the rules in the various jurisdictions may differ in details, most regulatory proceedings allow entities with a demonstrable interest to participate in the proceedings as parties to the case.

A regulatory proceeding involves not only the testimony of witnesses but also the production of technical, marketing, financial and economic data. For example, if the regulatory proceeding involves an increase in rates to support investment in new generating capacity, transmission capacity or other construction, additional evidence may be required to justify the investment, to assess the environmental and economic impacts, and to explain whether alternatives to the additional investment are available.

The regulatory process is fueled by information requests. The procedures for a specific proceeding determine the documents that must be filed by a regulated entity. Parties to the proceeding (the regulatory agency and formal participating parties) may make other data requests during the proceeding. In a single proceeding, the number of data requests may be in the hundreds or thousands. Moreover, each data request may comprise multiple queries (referred to herein as “questions”).

A response to a data request filed by a regulated entity is typically subject to review by diverse departments within a regulated entity. The time period established for filing responses to questions posed to the utility may be relatively short, requiring close coordination among departments within the utility. Adding to this complexity is the reality that a regulatory process may involve a number of state jurisdictions each with different procedures, different parties, different standards, and different issues.

Litigation management tools provide means for tracking documents and evidence in complex litigation. Tracking documents in databases is a useful tool in regulatory proceedings as well. However, what is not available are means to manage the data request process within a regulated entity over an electronic network. The data request process comprises timely management of the assignment, review, approval, and status of each data request in a regulatory proceeding. Because a regulatory proceeding may involve multiple jurisdictions, the management process may encompass managing similar requests in different jurisdictions with the responses due in diverse formats.

What is needed are means for managing data requests in a regulatory proceeding that enable the responsible individuals within a regulated entity to collaborate on the formulation of a regulated entity's filings and responses in a regulatory proceeding. Ideally, the means for managing the regulatory filing process would be platform independent, secure, and accessible to authorized individuals (including employees of a regulated entity and its consultants and advisors) via a public or private computer network.

### SUMMARY

An embodiment of the present invention provides a centralized data request management system (DRMS) that addresses the unique needs of regulated entities. Such entities include, but are not limited to, oil and gas companies, electric power companies and telecommunications companies. In an embodiment of the present invention, data requests relating to a regulatory proceeding are managed as a “docket.” Each docket is assigned to a “jurisdiction.” In an embodiment of the present invention, a jurisdiction is a political unit (a state or local government, or the federal government) with regulatory authority over the regulated entity. Associated with each docket are one or more requestors that have made data requests. Thus, a single jurisdiction may encompass a plurality of dockets each with different requesters.

In another embodiment of the present invention, rules are established at a docket level for determining how data requests are to be prepared, reviewed, and approved for publication to the requester. Docket-level rules may also be established at the requestor level to override the docket-level rules for a specific requester.

It is therefore an aspect of the present invention to facilitate management of a regulatory proceeding within a regulated entity.

It is another aspect of the present invention to facilitate responses by a regulated entity to data requests in regulatory proceedings.

It is yet another aspect of the present invention to provide an approval process within a regulated entity for responses to data requests in regulatory proceedings.

It is still another aspect of the present invention to provide an administrator oversight of all data requests made in a regulatory proceeding including the status of a data request, the location of a data request within a regulated entity's organization, and any issues posed by a particular data request.

It is an aspect of the present invention to facilitate management of a regulatory proceeding over multiple jurisdictions.

It is another aspect of the present invention to dramatically reduce time in establishing a framework for managing a regulatory proceeding and for delivering responses to data requests while increasing accuracy and consistency of responses to such matters.

It is yet another aspect of the present invention to provide access to the data request management system on a platform-independent basis from a central server and to provide an interface to internal and external organizations from which information may be drawn or to which information may be provided.

It is an aspect of the present invention to grant users access and edit privileges to information within the data request management system.

It is another aspect of the present invention to centralize the information in a regulatory proceeding for all jurisdictions and to permit the information to be searched.

It is still another aspect of the present invention to create templates of standard data requests, approval process rules and reports tailored for specific regulatory proceedings on a jurisdictional basis.

These and other aspects of the present invention will become apparent by reference to the drawings and descriptions that follow.

In an embodiment of the present invention a method for managing data requests over an electronic network received by a regulated entity comprises obtaining a proffered response to a data request, obtaining approval of the proffered response from each of one or more approvers, and providing the approved proffered response to a party from which the data request was received. Obtaining a proffered response to a data request comprises selecting a data request for response, designating a company user to proffer a response to the selected data request, and obtaining from the selected company user the proffered response to the selected data request. Obtaining approval of the proffered response from each of one or more approvers comprises assigning the proffered response to one or more departments for approval. The proffered response is submitted to an approval pool. One of the one or more departmental approvers is permitted to check-out the proffered response from the approval pool for review. In the event the reviewing departmental approver approves the proffered response, the proffered response is returned to the approval pool. The process also comprises determining whether all of the one or more departmental approvers have approved the proffered response. In the event that any of the one or more departmental approvers have not approved the proffered response, a different one of the one or more departmental approvers is permitted to check-out the proffered response from the approval pool for review. If that departmental approver approves the proffered response, the proffered response is returned to the approval pool and a determination is made if any of the one or more departmental approvers have not approved the proffered response. Unless a departmental approver does not approve the proffered response, this process continues until all of the one or more departmental approvers have approved the proffered response. In that event, the proffered response is deemed approved.

Alternatively, obtaining approval of the proffered response from each of one or more approvers comprises designating one or more company approvers to approve the proffered response. The proffered response is submitted to an approval pool. One of the one or more company approvers is permitted to check-out the proffered response from the approval pool for review. In the event the reviewing company approver approves the proffered response, the proffered response is returned to the approval pool. The process further comprises determining whether all of the one or more company approvers have approved the proffered response. In the event that any of the one or more company approvers have not approved the proffered response, a different one of the one or more company approvers is permitted to check-out the proffered response from the approval pool for review. If that company approver approves the proffered response, the proffered response is returned to the approval pool and a determination is made if any of the one or more company approvers have not approved the proffered response. Unless a company approver does not approve the proffered response, this process continues until all of the one or more company approvers have approved the proffered response. In that event, the proffered response is deemed approved.

In another embodiment of the present invention a method for managing data requests received by a regulated entity comprises entering a docket for a regulatory proceeding into a docket folder within a docket datastore, associating with each docket folder one or more data requestors each having submitted one or more data requests in the regulatory proceeding, associating with each data requester the one or more data requests made by that party requester, and saving each data request made by each of the one or more party requesters in a data request folder within the docket datastore. In another embodiment of the present invention, this method further comprises selecting one of the one or more data requests from the data request folder, designating in the response structure a selected company user selected from the user folder of the regulated entity to proffer a response to the selected data request, and obtaining from the selected company user the proffered response to the selected data request.

In another embodiment of the present invention, a system for managing data requests received by a regulated entity comprises a datastore for receiving one or more data requests and a data request management server. The data request management server is connected to the datastore. The data request management server is adapted to respond to instructions to select a data request for response, associate a data request with a company user for response, receive a proffered response to the data request from the company user, obtain approval of the proffered response from each of one or more approvers, and provide an approved proffered response to a party from which the data request was received. In still another embodiment of the present invention this system further comprises a network and a network interface connected to the network and to the data request management server, wherein the data request management server is accessible to one or more users via the network interface. By way of illustration and not as a limitation, the network may be a wired network, a wireless network, a local area network, a wide area network, a private network, a virtual private network, or the Internet.

In another embodiment of the present invention, the data request management server is further adapted to respond to instructions to associate the proffered response with one or more departments for approval, to respond to instructions to submit the proffered response to an approval pool, and to permit one of the one or more departmental approvers to check-out the proffered response from the approval pool for review. The data request management server is also adapted to return the proffered response to the approval pool in the event the reviewing departmental approver approves the proffered response. Additionally, the data request management server is adapted to determine whether all of the one or more departmental approvers have approved the proffered response. In the event that any of the one or more departmental approvers have not approved the proffered response, the data request management server is adapted to permit a different one of the one or more departmental approvers to check-out the proffered response from the approval pool for review. Unless a departmental approver does not approve the proffered response, the data request management server is adapted to continue this process until all of the one or more departmental approvers have approved the proffered response. In that event, the proffered response is deemed approved.

In another embodiment of the present invention, the data request management server is further adapted to respond to instructions to associate the proffered response with one or more company approvers for approval, to respond to instructions to submit the proffered response to an approval pool, and to permit one of the one or more company approvers to check-out the proffered response from the approval pool for review. The data request management server is also adapted to return the proffered response to the approval pool in the event the reviewing company approver approves the proffered response. Additionally, the data request management server is adapted to determine whether all of the one or more company approvers have approved the proffered response. In the event that any of the one or more company approvers have not approved the proffered response, the data request management server is adapted to permit a different one of the one or more company approvers to check-out the proffered response from the approval pool for review. Unless a company approver does not approve the proffered response, the data request management server is adapted to continue this process until all of the one or more company approvers have approved the proffered response. In that event, the proffered response is deemed approved.

An embodiment of the present invention provides a centralized data request X management system (DRMS) that addresses the unique needs of regulated entities. The responsibility for managing a DRMS is determined by the regulated entity. In the discussion that follows, an “Administrator” fills this management role. However, this term is not meant to be limiting. By way of illustration and not as limitation, the “Administrator” may be an individual, a group of individuals, or an organization with the regulated entity or authorized by the regulated entity without departing from the scope of the present invention.

In an embodiment of the present invention, an Administrator receives a data request from a requesting party and provides it to a user who creates a proffered response. The user may elect to provide the proffered response to a reviewer for comment and then submit the proffered response to an Administrator or may simply return the proffered response to the Administrator without assistance from a reviewer. An Administrator uses an Approval Pool to obtain final approval of the proffered response. The approved response is then ready for publication and delivery to the requesting party.

In another embodiment of the present invention, a system and method for managing data requests of a regulated entity in a regulatory proceeding using a DRMS comprises means for establishing a set of roles based on access permissions. Individual users may access various components of the DRMS based on the role of that user. An Administrator enters one or more jurisdictions into a jurisdiction datastore, enters one or more requestors into a requestor folder within a requestor datastore, and enters one or more users into a user folder within a requestor folder. A regulated entity is by default a requestor. Each user is assigned a role from the set of roles.

In another embodiment of the present invention, an Administrator enters a docket into a docket folder within the docket datastore for a regulatory proceeding. The docket folder comprises a data request folder for each data request made in the regulatory proceeding to which the docket folder is associated. Each data request comprises one or more questions assigned to a question folder. A set of party requesters selected from the requestor folder is also associated with the docket folder. The party requestors are the participants in the particular regulatory proceeding associated with the particular docket. A data request is associated with the party requestor that made the data request.

In yet another embodiment of the present invention, a question within a question folder is also associated with a response structure established by an Administrator that determines the process by which a response to a question will be approved for publication to the requestor.

In an embodiment of the present invention, a system for managing data requests comprises a server that controls a user interface and the DRMS. The DRMS is adapted to establish a set of roles based on access permissions, store one or more jurisdictions in a jurisdiction datastore, and store one or more requestors in a requestor folder within a requestor datastore. The regulated entity that is using the DRMS is by default one of the one or more requesters. The DRMS is further adapted to store one or more users in a user folder within a requestor folder and to assign a user a role from the set of roles. The role of a user determines the components of the DRMS to which that user has access.

The DRMS stores a docket in a docket folder within the docket datastore. The docket folder comprises a data request folder and the data request folder comprises a question folder. The DRMS associates the each docket folder a set of party requesters selected from the requestor folder. Each party requestor is associated with a data request made by that party requestor. The data request comprises one or more questions that are each maintained in a question record in the question folder. Each question folder comprises a response structure established by the Administrator that determines the process by which a response to a question will be approved for publication to the requestor.

### DESCRIPTION OF THE DRAWINGS

FIG. 1 illustrates a DRMS according to an embodiment of the present invention.

FIG. 2 illustrates a DRMS according to an embodiment of the present invention.

FIG. 3 illustrates a process by which one or more of the folders of the DRMS are populated using a template

FIGS. 4A, 4B, and 4C illustrate a logical flow of a data request process in a DRMS according to one or more embodiments of the present invention

### DETAILED DESCRIPTION

The following terms used in the description that follows. The definitions are provided for clarity of uriderstanding:
Administrator—includes a person, group of persons, or organization that manages the DRMS or a component thereof and that is ultimately responsible for producing a response to a data request received from a requester.
Approval pool—an electronic “folder” shared by user approvers and department approver wherein an Administrator may deposit a proffered response for checkout by an approver.
Company user—any individual assigned to prepare a response to a question.
Data request—a query from a requester for data directed to a regulated entity. A data request may comprise one or more questions.
Docket—an organizational object comprising the data requests, the questions, and the requestors associated with a particular regulatory proceeding.
Electronic network (or network)—a computer network comprising hardware; software, and communication means, including wired networks, wireless networks, local area networks, wide area networks, private networks, virtual private networks, and the Internet.
Jurisdiction—a political unit (a state or local government, or the federal government) with regulatory authority over the regulated entity.
Proffered response—a response to a question proffered by a user.
Question—a component of a data request.
Regulated entity—an entity that is subject to the authority of a regulatory agency.
Requestor—a participant in a regulatory proceeding.
Regulatory proceeding—a proceeding before a regulatory agency in which a regulated entity is the applying party.
Reviewer—an individual within a regulated entity assigned to review a proffered response. A review may comment on a proffered response but may not edit that response.
User approver—an individual within a regulated entity assigned to approve a proffered response.

An embodiment of the present invention is a centralized data request management system (DRMS) that addresses the unique needs of regulated entities in managing regulatory proceedings. Such entities include, but are not limited to, oil and gas companies, electric power companies and telecommunications companies.

Control of the DRMS lies with an Administrator. In theory, the Administrator may receive all of the data requests from all the data requesters, prepare all the responses, and publish the responses to the data requesters. In practice, the Administrator delegates the responsibility for receiving data requests and preparing responses to others using the organizational and decision making tools of the DRMS while retaining the ultimate power to decide what data is actually provided to a requestor.

In an embodiment of the present invention, a method for managing data requests over an electronic network received by a regulated entity comprises obtaining a proffered response to a data request, obtaining approval of the proffered response from each of one or more approvers, and providing the approved proffered response to a party from which the data request was received. Obtaining a proffered response to a data request comprises selecting a data request for response, designating a company user to proffer a response to the selected data request, and obtaining from the selected company user the proffered response to the selected data request. In an embodiment of the present invention, obtaining approval of the proffered response from each of one or more approvers comprises assigning the proffered response to one or more departments for approval. The proffered response is submitted to an approval pool. One of the one or more departmental approvers is permitted to check-out the proffered response from the approval pool for review. In the event the reviewing departmental approver approves the proffered response, the proffered response is returned to the approval pool. The process also comprises determining whether all of the one or more departmental approvers have approved the proffered response. In the event that any of the one or more departmental approvers have not approved the proffered response, a different one of the one or more departmental approvers is permitted to check-out the proffered response from the approval pool for review. If that departmental approver approves the proffered response, the proffered response is returned to the approval pool and a determination is made if any of the one or more departmental approvers have not approved the proffered response. Unless a departmental approver does not approve the proffered response, this process continues until all of the one or more departmental approvers have approved the proffered response. In that event, the proffered response is deemed approved. In the event that any one of the one or more departmental approvers objects to the proffered response, the proffered response is returned to an Administrator.

Alternatively, obtaining approval of the proffered response from each of one or more approvers comprises designating one or more company approvers to approve the proffered response. The proffered response is submitted to an approval pool. One of the one or more company approvers is permitted to check-out the proffered response from the approval pool for review. In the event the reviewing company approver approves the proffered response, the proffered response is returned to the approval pool. The process further comprises determining whether all of the one or more company approvers have approved the proffered response. In the event that any of the one or more company approvers have not approved the proffered response, a different one of the one or more company approvers is permitted to check-out the proffered response from the approval pool for review. If that company approver approves the proffered response, the proffered response is returned to the approval pool and a determination is made if any of the one or more company approvers have not approved the proffered response. Unless a company approver does not approve the proffered response, this process continues until all of the one or more company approvers have approved the proffered response. In that event, the proffered response is deemed approved. In the event that any one of the one or more company approvers objects to the proffered response, the proffered response is returned to an Administrator. In another embodiment of the present invention, if one or more company approvers are designated, an assignment of the proffered response to one or more departments for approval is overridden.

In still another embodiment of the present invention, a method for managing data requests over an electronic network received by a regulated entity comprises receiving an assignment of a data request, preparing a draft proffered response to the data request, submitting the draft proffered response to a reviewer, receiving from the reviewer one or more comments to the draft proffered response, and preparing a proffered response to the data request.

In another embodiment of the present invention a method for managing data requests over an electronic network received by a regulated entity comprises entering a docket for a regulatory proceeding into a docket folder within a docket datastore, associating with each docket folder one or more data requestors each having submitted one or more data requests in the regulatory proceeding, associating with each data requestor the one or more data requests made by that party requester, and saving each data request made by each of the one or more party requesters in a data request folder within the docket datastore. In another embodiment of the present invention, this method further comprises selecting one of the one or more data requests from the data request folder, designating in the response structure a selected company user selected from the user folder of the regulated entity to proffer a response to the selected data request, and obtaining from the selected company user the proffered response to the selected data request.

In an embodiment of the present invention, the method further comprises assigning the proffered response to one or more departments for approval. The proffered response is submitted to an approval pool. One of the one or more departmental approvers is permitted to check-out the proffered response from the approval pool for review. In the event the reviewing departmental approver approves the proffered response, the proffered response is returned to the approval pool. The process also comprises determining whether all of the one or more departmental approvers have approved the proffered response. In the event that any of the one or more departmental approvers have not approved the proffered response, a different one of the one or more departmental approvers is permitted to check-out the proffered response from the approval pool for review. If that departmental approver approves the proffered response, the proffered response is returned to the approval pool and a determination is made if any of the one or more departmental approvers have not approved the proffered response. Unless a departmental approver does not approve the proffered response, this process continues until all of the one or more departmental approvers have approved the proffered response. In that event, the proffered response is deemed approved. In the event that any one of the one or more assigned departments objects to the proffered response, the proffered response is returned to an Administrator.

In an alternate embodiment, the method further comprises designating one or more company approvers to approve the proffered response. The proffered response is submitted to an approval pool. One of the one or more company approvers is permitted to check-out the proffered response from the approval pool for review. In the event the reviewing company approver approves the proffered response, the proffered response is returned to the approval pool. The process further comprises determining whether all of the one or more company approvers have approved the proffered response. In the event that any of the one or more company approvers have not approved the proffered response, a different one of the one or more company approvers is permitted to check-out the proffered response from the approval pool for review. If that company approver approves the proffered response, the proffered response is returned to the approval pool and a determination is made if any of the one or more company approvers have not approved the proffered response. Unless a company approver does not approve the proffered response, this process continues until all of the one or more company approvers have approved the proffered response. In that event, the proffered response is deemed approved. In the event that any one of the one or more company approvers objects to the proffered response, the proffered response is returned to an Administrator. In another embodiment of the present invention, if one or more company approvers are designate, any assignment of the proffered response to one or more departments for approval is overridden.

In an embodiment of the present invention, entering a docket for a regulatory proceeding into a docket folder within a docket datastore comprises selecting a regulatory proceeding type and a jurisdiction, and populating the docket folder based on the specified regulatory proceeding type and the specified jurisdiction. In another embodiment of the present invention, entering a docket for a regulatory proceeding into a docket folder within a docket datastore comprises selecting a regulatory proceeding type and a jurisdiction, and selecting a template for the proceeding type within the specified jurisdiction, wherein the template populates the docket folder.

In another embodiment of the present invention, a system for managing data requests received over an electronic network by a regulated entity comprises a datastore for receiving one or more data requests and a data request management server. The data request management server is connected to the datastore. The data request management server is adapted to respond to instructions to select a data request for response, associate a data request with a company user for response, receive a proffered response to the data request from the company user, obtain approval of the proffered response from each of one or more approvers, and provide an approved proffered response to a party from which the data request was received. In still another embodiment of the present invention this system further comprises a network and a network interface connected to the network and to the data request management server, wherein the data request management server is accessible to one or more users via the network interface. By way of illustration and not as a limitation, the network may be a wired network, a wireless network, a local area network, a wide area network, a private network, a virtual private network, or the Internet.

In another embodiment of the present invention, the data request management server is further adapted to respond to instructions to associate the proffered response with one or more departments for approval, to respond to instructions to submit the proffered response to an approval pool, and to permit one of the one or more departmental approvers to check-out the proffered response from the approval pool for review. The data request management server is also adapted to return the proffered response to the approval pool in the event the reviewing departmental approver approves the proffered response. Additionally, the data request management server is adapted to determine whether all of the one or more departmental approvers have approved the proffered response. In the event that any of the one or more departmental approvers have not approved the proffered response, the data request management server is adapted to permit a different one of the one or more departmental approvers to check-out the proffered response from the approval pool for review. Unless a departmental approver does not approve the proffered response, the data request management server is adapted to continue this process until all of the one or more departmental approvers have approved the proffered response. In that event, the proffered response is deemed approved. In another embodiment of the present invention, in the event that any one of the one or more company approvers objects to the proffered response, the data request management system is adapted to return the proffered response to an administrator.

In another embodiment of the present invention, the data request management server is further adapted to respond to instructions to associate the proffered response with one or more company approvers for approval, to respond to instructions to submit the proffered response to an approval pool, and to permit one of the one or more company approvers to check-out the proffered response from the approval pool for review. The data request management server is also adapted to return the proffered response to the approval pool in the event the reviewing company approver approves the proffered response. Additionally, the data request management server is adapted to determine whether all of the one or more company approvers have approved the proffered response. In the event that any of the one or more company approvers have not approved the proffered response, the data request management server is adapted to permit a different one of the one or more company approvers to check-out the proffered response from the approval pool for review. Unless a company approver does not approve the proffered response, the data request management server is adapted to continue this process until all of the one or more company approvers have approved the proffered response. In that event, the proffered response is deemed approved. In another embodiment of the present invention, in the event that any one of the one or more company approvers objects to the proffered response, the data request management system is adapted to return the proffered response to an administrator. In another embodiment of the present invention, when one or more company approvers are designated to approve the proffered response, the data request management server is further adapted to override an assignment of the proffered response to one or more departments for approval.

In still another embodiment of the present invention, a system for managing data requests received by a regulated entity comprises a docket datastore. The docket datastore comprises a docket folder associated with a regulatory proceeding. The docket folder comprises one or more data requesters each having submitted one or more data requests in the regulatory proceeding, one or more data requests submitted by any of the one or more data requesters, and one or more users associated with each of the one or more data requesters. The data request management system further comprises a data request management server, wherein the server is adapted to communicate with the docket datastore.

In another embodiment of the present invention, the data request management server is further adapted to respond to instructions to create a set of user roles, and wherein each of the one or more-users is assigned a user role. In still another embodiment of the present invention, the user role assigned to each of the one of the more users determines a level of access of that user to the data request management server.

In another embodiment of the present invention, the system further comprises an electronic network, and a network interface connected to the electronic network and to the data request management server. The data request management server is accessible to one or more users via the network interface. By way of illustration and not as a limitation, the electronic network may be a wired network, a wireless network, a local area network, a wide area network, a private network, a virtual private network, and the Internet.

In still another embodiment of the present invention, the data request management server is further adapted to respond to instructions to select a data request for response, associate the selected data request with a company user for response, receive a proffered response to the selected data request from the company user, obtain approval of the proffered response from each of one or more approvers, and provide an approved proffered response to a party from which the data request was received.

In another embodiment of the present invention, the data request management server is further adapted to respond to instructions to associate the proffered response with one or more departments for approval, to respond to instructions to submit the proffered response to an approval pool, and to permit one of the one or more departmental approvers to check-out the proffered response from the approval pool for review. The data request management server is also adapted to return the proffered response to the approval pool in the event the reviewing departmental approver approves the proffered response. Additionally, the data request management server is adapted to determine whether all of the one or more departmental approvers have approved the proffered response. In the event that any of the one or more departmental approvers have not approved the proffered response, the data request management server is adapted to permit a different one of the one or more departmental approvers to check-out the proffered response from the approval pool for review. Unless a departmental approver does not approve the proffered response, the data request management server is adapted to continue this process until all of the one or more departmental approvers have approved the proffered response. In that event, the proffered response is deemed approved. In another embodiment of the present invention, in the event that any one of the one or more company approvers objects to the proffered response, the data request management system is adapted to return the proffered response to an administrator.

In another embodiment of the present invention, the data request management server is further adapted to respond to instructions to associate the proffered response with one or more company approvers for approval, to respond to instructions to submit the proffered response to an approval pool, and to permit one of the one or more company approvers to check-out the proffered response from the approval pool for review. The data request management server is also adapted to return the proffered response to the approval pool in the event the reviewing company approver approves the proffered response. Additionally, the data request management server is adapted to determine whether all of the one or more company approvers have approved the proffered response. In the event that any of the one or more company approvers have not approved the proffered response, the data request management server is adapted to permit a different one of the one or more company approvers to check-out the proffered response from the approval pool for review. Unless a company approver does not approve the proffered response, the data request management server is adapted to continue this process until all of the one or more company approvers have approved the proffered response. In that event, the proffered response is deemed approved. In another embodiment of the present invention, in the event that any one of the one or more company approvers objects to the proffered response, the data request management system is adapted to return the proffered response to an administrator. In another embodiment of the present invention, when one or more company approvers are designated to approve the proffered response, the data request management server is further adapted to override an assignment of the proffered response to one or more departments for approval.

In an embodiment of the present invention, upon creation of a new docket with a docket datastore, the data request management server is further adapted to request a docket jurisdiction and a proceeding type. In the event the docket jurisdiction and proceeding type are provided, the data request management server is adapted to populate the docket folder. In another embodiment of the present invention, the data request management server is further adapted to respond to instructions to select a docket template, and populate docket folder based on the content of the docket template.

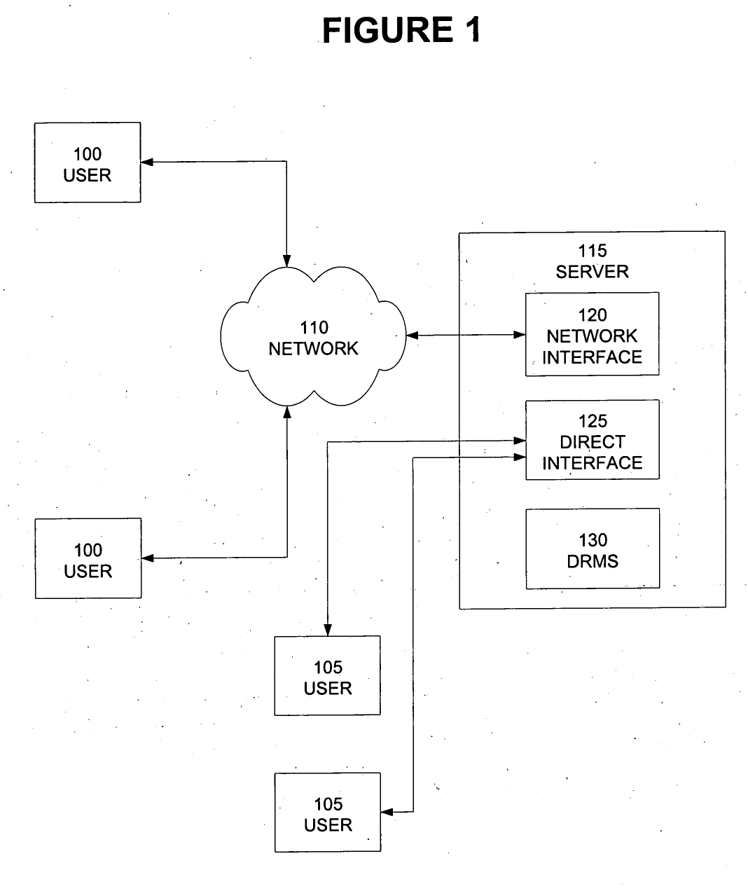

FIG. 1 illustrates a block diagram of a DRMS implement on a server in accordance with an embodiment of the present invention. Server 115 comprises a network interface 120, a direct interface 125, and a DRMS 130. Users 100 access the server 115 and the DRMS 130 via network 110 and network interface 120. Users 105 access the server 115 and the DRMS 130 via the direct interface 125. In an embodiment of the present invention, server 115 is a Web server and network 110 is the Internet. In this embodiment of the present invention the DRMS may be updated “on-the-fly” allowing subscribing regulated entities to have remote access to the latest features and templates at all times. However, the present invention is not so limited. As will be apparent to those skilled in the art, various networks may be used to connect users with the network interface without departing from the scope of the present invention. By way of illustration and not as a limitation, network 110 may be a wired network, a wireless network, a local area network, a wide area network, a private network, or a virtual private network.

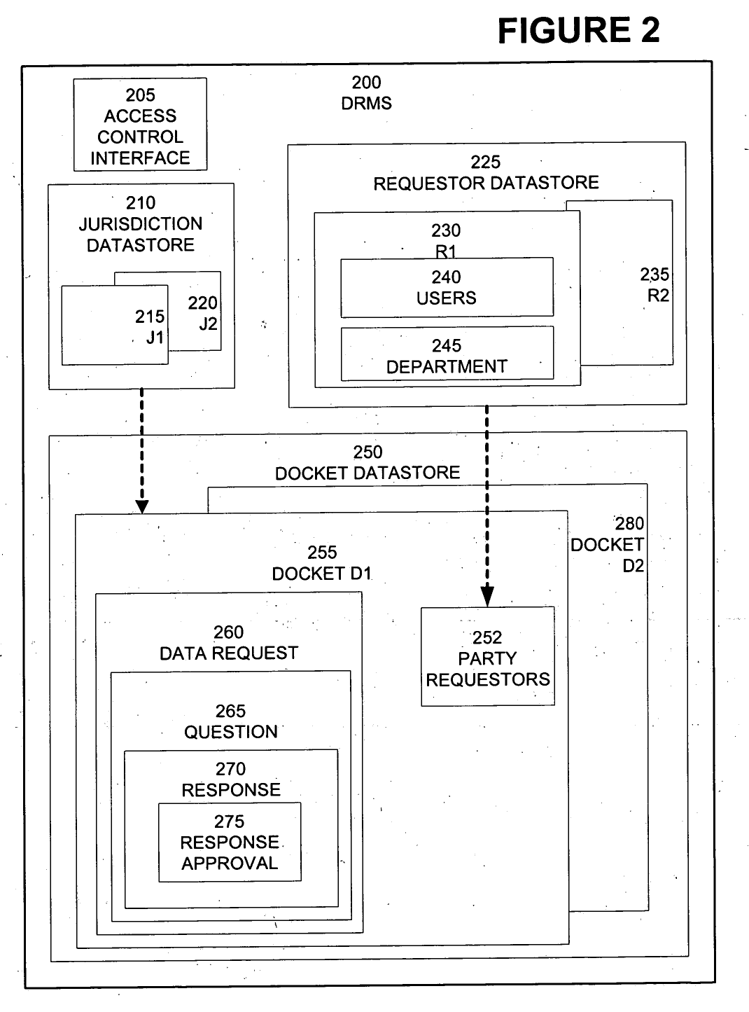

In an embodiment of the present invention, docket request management tasks are subject to a set of rules established by an Administrator. FIG. 2 illustrates a DRMS according to an embodiment of the present invention. Referring to FIG. 2, the DRMS 200 comprises an access control interface 205. The access control interface 205 manages access to the DRMS 200 modules via access rules established by an Administrator. Access by a user is regulated by defining roles based on access rights and assigning a role to that user. By way of illustration and not as a limitation, the following permissions can be combined to create new roles within the DMRS:
Jurisdiction Administration Rights. If granted, the user can see, create, edit and delete jurisdiction records.
Department Administration Rights. If granted, the user can see, create, edit and delete department records.
Requestor Administration Rights. If granted, the user can see, create, edit and delete requester (party) records.
Docket Administration Rights. If granted, the user can see, create, edit and delete docket records.
User Administrator Rights. If granted, the user can see, create, edit and delete user records.
Data Request Administration Rights. If granted, the user can see, create, edit and delete data request records.
Data Request Question Administration Rights. If granted, the user can see, create, edit and delete data request question records.
Message Usage Rights. If granted, the user can send messages within the DRMS.
Right to let the user reassign a question to someone else. If granted, the user can reassign any item assigned to him.
Roles Administration Rights. If granted, the user can see, create, edit and delete roles records.
Access To System Reports Rights. If granted, the user can access system reports.
Search Ability. If granted, the user can use a full-text search feature of the DRMS 200.
System Administration Rights. If granted, the user can change the technical settings of the DRMS 200.

A jurisdiction datastore 210 manages one or more jurisdictions in which a regulated entity is involved in regulatory proceedings. In FIG. 2, jurisdiction folders J1 215 and J2 220 are illustrated, but this is not meant as a limitation. Any number of jurisdictions may be managed by the DRMS 200.

A requestor datastore 225 identifies the requestors identified to the DRMS 200 in each of the dockets managed by the DRMS 200. In FIG. 2, requester folders R1 230 and R2 240 are illustrated, but this is not meant as a limitation. Any number of requestors may be managed by the DRMS 200. While illustrated only for requestor folder R1 230, each requestor folder within the requestor datastore 225 has associated with it a users folder 240 comprising a set of users and a departments folder 245 comprising a set of departments. The set of users comprises a list of individuals “belonging” to the requestor and the role of that individual. The set of departments comprises the departments of the requestors that are involved in any of the regulatory proceedings in which a regulated entity is involved.

A regulated entity is by default a requester. The user folder of a regulated entity defines the roles of individuals within a regulated entity who are involved with the regulatory proceeding. The users and departments of a regulated entity identified in the requestor datastore 225 are utilized in the response and approval processes described below.

A docket datastore 250 comprises data related to each regulatory proceeding in which a regulated entity is involved. In FIG. 2, docket folders D1 255 and D2 280 are illustrated, but this is not meant as a limitation. Any number of dockets may be managed by the DRMS 200. A docket is associated with a jurisdiction (indicated by the broken lines connecting docket D1 255 to jurisdiction datastore 210) and a set of party requesters 252 selected from requestor datastore 225.

While only illustrated for docket folder D1 255, each docket folder comprises a party requestors folder 252 and a data requests folder 260 comprising one or more data requests. Each data request folder comprises a questions folder comprising a set of questions 265. A question is linked to a response structure 270 and a response approval structure 275. The response structure comprises the users to whom a question within a data request is assigned for initial response (also referred to herein as a “proffered response”). In an embodiment of the present invention, an individual is identified as a candidate for receiving an assignment by virtue of having been given the role of “company user” by the Administrator.

The response approval structure 275 determines how a proffered response is approved within a regulated entity. In an embodiment of the present invention, the proffered response is approved on a department level based on the departments selected from a list of departments identified in the departments folder associated with a regulated entity (245). Optionally, the list of departments identified in the departments folder associated with the regulated entity is populated from a database of departments linked to the departments folder. If the Administrator assigns the approval of a proffered response to a user approver, the departmental level review settings are overridden by the DRMS.

FIG. 2 illustrates a logical structure according to an embodiment of the present invention. As will be appreciated by those skilled in the art, other logical structures may be assigned to perform the roles of the structures illustrated in FIG. 2 hereof without departing from the scope of the present invention.

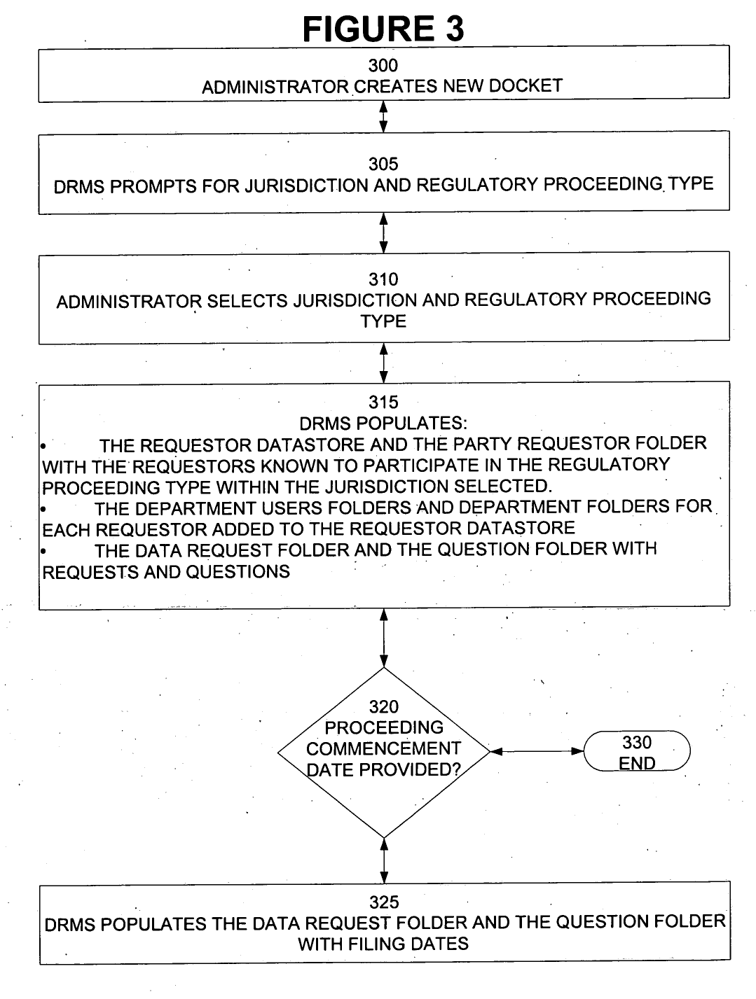

An Administrator populates the folders within the datastores illustrated in FIG. 2. In an embodiment of the present invention this process is accomplished by direct entry into the datastore folders. FIG. 3 illustrates a process by which one or more of the folders of the DRMS are populated using a template. Referring to FIGS. 2 and 3, an Administrator creates a new docket within a docket datastore 300 (FIG. 1, 250). The DRMS (FIG. 1, 200) prompts an Administrator for the jurisdiction and the type of regulatory proceeding that is to be assigned to the new docket within a docket datastore 305. For example, the regulatory proceeding may be a rate hearing. Upon selection of the jurisdiction and the regulatory proceeding type 310, the DRMS populates a requestor datastore 315 (FIG. 1, 225) and the party requestor folder (FIG. 1, 252) within the docket folder with the requestors known to participate in the regulatory proceeding type within the jurisdiction selected. The DRMS also populates a department users folder and a department folder for each requester added to a requestor datastore 315. To the extent known, the DRMS further populates a data request folder and a question folder 315 (FIG. 1, 260 and 265) for a selected proceeding.

A data request folder 260 and a question folder 265 are populated with data requests dictated by the regulatory agency that presides over the selected regulatory proceeding. If an Administrator 320 also provides a proceeding commencement date, a data request folder 260 and a question folder 265 will also be populated with any filing dates associated with the requests and questions 325. Otherwise, the process ends 330.

An Administrator may override the population template for any datastore folder.

In another embodiment of the present invention, each datastore folder is individually populated based on a template list associated with the proceeding type and jurisdiction selected by the Administrator.

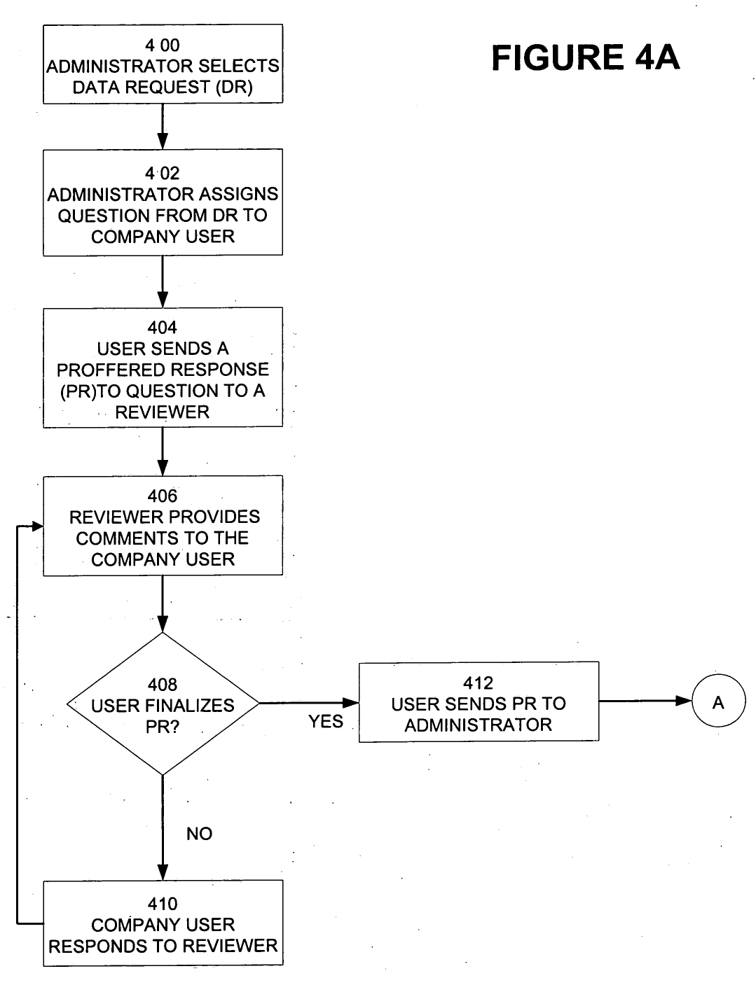

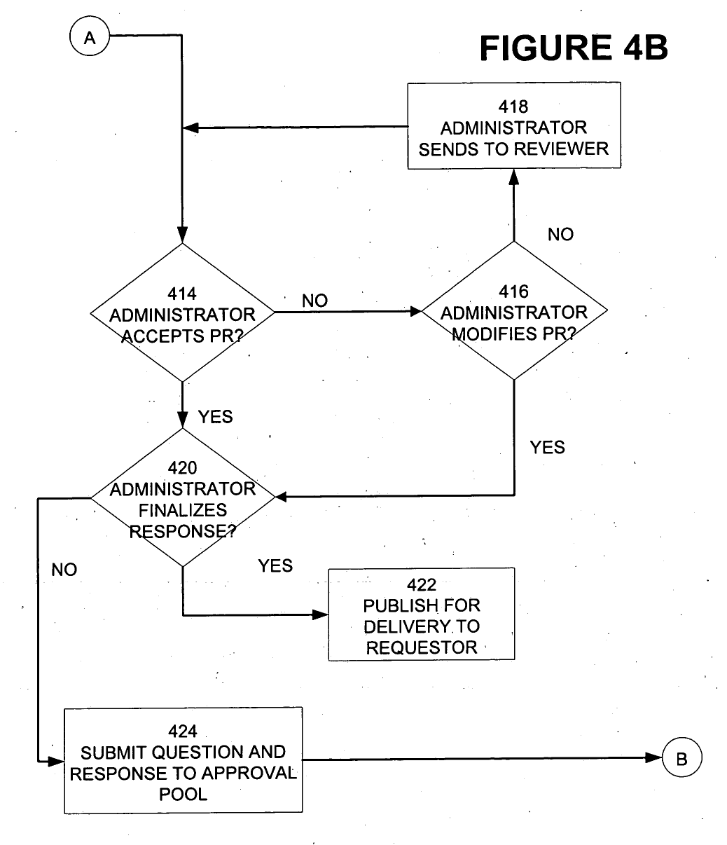

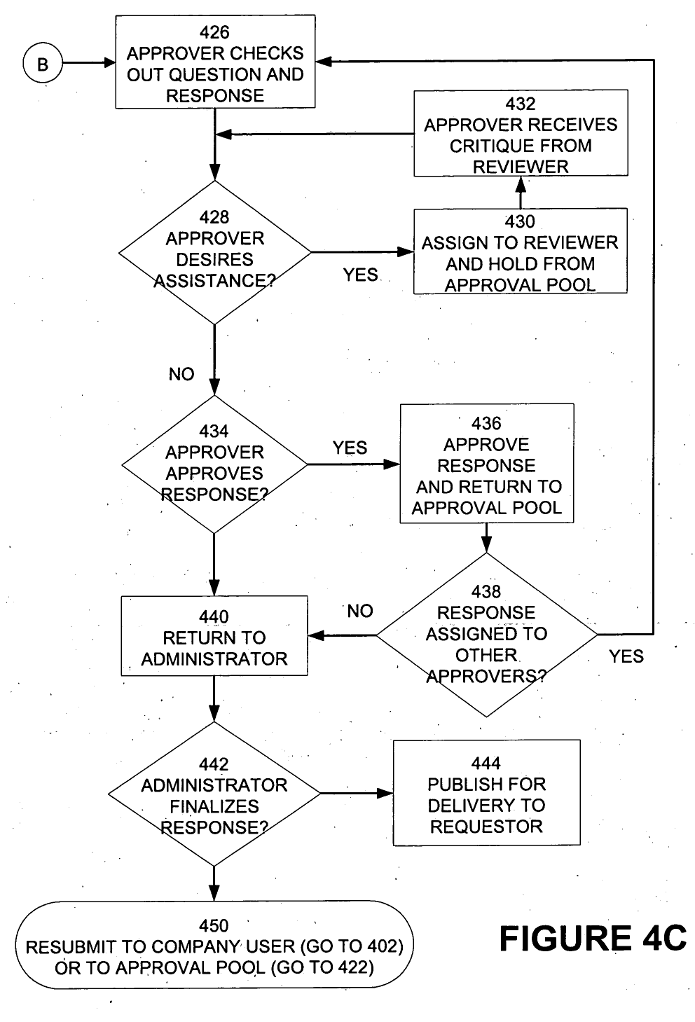

As noted previously, in an embodiment of the present invention, an Administrator controls the management of data requests and questions. The DRMS provides an Administrator tools to efficiently manage all of the data requests of a particular docket. FIGS. 4A, 4B, and 4C illustrate a logical flow of a data request process in a DRMS according to various embodiments of the present invention. Referring to FIG. 4A, an Administrator selects a data request (DR) 400 and assigns the DR to a company user 402 who is charged with creating a proffered response. The company user provides the proffered response to a reviewer 404 for comment. (The reviewer may comment but may not change the proffered response.) The reviewer provides comments on the proffered response to a company user 406. The company user may finalize the response or respond to the reviewer 408. If the company user responds to the reviewer, the reviewer may provide additional comments 406 and the company user is again in a position to finalize the proffered response 408. While there is no limit to the number of exchanges that may take place between the company user and a reviewer, the company user is tasked with producing a proffered response within a time period and will ultimately finalize the proffered response and send it to the Administrator 412.

Referring to FIG. 4B, an Administrator reviews the proffered response and determines whether to accept the proffered response 414. As illustrated in FIG. 4B, if the Administrator does not accept the proffered response, the Administrator may elect to modify the proffered response 416 and continue the process or may chose to submit the proffered response to a reviewer for comment 418. According to an embodiment of the present invention, the reviewer may only critique the proffered response. An Administrator receives the comments of the reviewer and again determines whether to accept the proffered response 414 or modify it 416. While there is no limit to the number of exchanges that may take place between an Administrator and a reviewer, the Administrator is tasked with producing a response to a data request within a time period and will ultimately accept the proffered response or modify the proffered response and continue the approval process.

Once an Administrator approves a proffered response, that proffered response is referred to as a “response” to the data request or data request question. An Administrator may finalize the response without further review 418. The authority of an Administrator to finalize a response is an internal matter for a regulated entity. If an Administrator finalizes the response, the response is then published for delivery to the requestor 422. Alternatively, an Administrator may submit the question and the response to an Approval Pool for approval by others within a regulated entity 424.

The Approval Pool is an electronic “folder” shared by authorized approvers whether they are individually selected by the Administrator or assigned at the department level. According to an embodiment of the present invention, the Approval Pool operates on a “first come, first served” basis. Referring to FIG. 4C, an approver “checks out” the question and the response from an Approval Pool 426. The approver now has possession of the question and the proffered response. No other approver can access the question once and proffered response once it is transferred from the pool. (An Administrator may, however, withdraw the question and the response from the Approval Pool and simply approve the response.)

The approver determines whether assistance is needed 428. If the approver desires assistance, the approver assigns the response to a reviewer 430 and receives a critique from the reviewer 432. The approver decides if further assistance is needed 428. While there is no limit to the number of exchanges that may take place between the approver and a reviewer, the approver is tasked with producing a response to a data request within a time period and will ultimately approve or reject a response and continue the approval process.

The approver determines whether to approve the response 434. If the response is rejected, the approver returns the response to an Administrator with an explanation of the reasons for the rejection 440. An Administrator may finalize the response (with or without modification) in which case the response is published for delivery to the requestor 444. Alternatively, an Administrator may elect to modify the response and reassign the question to a user 402 or resubmit the response as modified to the Approval Pool 422.

If an approver approves the response 434, that approver returns the response and the question to the Approval Pool 436. If the response is assigned to other approvers for approval, the process continues with the next approver checking out the question and the response from the Approval Pool 426. If no other approvers are assigned to the response, the response is returned to an Administrator 442 who may take the actions previously described.

Referring again to FIG. 1, the present invention provides an Administrator a view of all regulatory proceedings in which the regulatory entity is involved. In an embodiment of the present invention, questions directed to “related” information are identified by the DRMS and flagged for the Administrator. Using a relational parsing algorithm, the DRMS reviews the questions in the questions folders to determine if two data requests are related and alerts an Administrator that a response may have been prepared for different requestors in the same docket, or for the same or different requestors in different dockets in the same or different jurisdictions. An Administrator can use this report to determine whether to simply duplicate the response or to assign a question to a company user who is familiar with the subject matter. Additionally, the Administrator can take steps to assure that similar data requests are handled uniformly across all requesters, dockets and jurisdictions.

In another embodiment of the present invention, the DRMS indexes all uploaded and entered data in real time, building a corporate memory over time. Attachment files from office suites such as Microsoft® Office® (Word®, Excel®, PowerPoint®), Lotus Smartsuite®, Wordperfect®, etc. are also fully searchable as well as plain text files, HTML and XML documents.

Search results, similar to common Internet search engines, are sorted according to their relevance ranking in the database. Using a natural language search interface, a search can be conducted for specific words and/or phrases. A Boolean search interface allows for more precise searches.

A system and method of managing data requests by a regulated entity involved in a regulatory proceeding has been described. It will be understood by those skilled in the art of the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

1. A method for managing data requests over an electronic network received by a regulated entity comprising:
obtaining a proffered response to a data request;
obtaining approval of the proffered response from each of one or more approvers; and
providing the approved proffered response to a party from which the data request was received.

2. The method for managing data requests over an electronic network received by a regulated entity of claim 1, wherein obtaining a proffered response to a data request comprises:
selecting a data request for response;
designating a company user to proffer a response to the selected data request; and
obtaining from the selected company user the proffered response to the selected data request.

3. The method for managing data requests over an electronic network received by a regulated entity of claim 1, wherein obtaining approval of the proffered response from each of one or more approvers comprises:
(a) assigning the proffered response to one or more departments for approval;
(b) submitting the proffered response to an approval pool;
(c) permitting one of the one or more departmental approvers to check-out the proffered response from the approval pool for review;
(d) in the event the reviewing departmental approver approves the proffered response, returning the proffered response to the approval pool;
(e) determining whether all of the one or more departmental approvers have approved the proffered response;
(f) in the event that any of the one or more departmental approvers have not approved the proffered response, permitting a different one of the one or more departmental approvers to check-out the proffered response from the approval pool for review and returning to step (d); and
(g) in the event that all of the one or more departmental approvers have approved the proffered response, determining that the proffered response is approved.

4. The method for managing data requests over an electronic network received by a regulated entity of claim 3, wherein the method further comprises in the event that any one of the one or more assigned departments objects to the proffered response, returning the proffered response to an administrator.

5. The method for managing data requests over an electronic network received by a regulated entity of claim 1, wherein obtaining approval of the proffered response from each of one or more approvers comprises:
(a) designating one or more company approvers to approve the proffered response;
(b) submitting the proffered response to an approval pool;
(c) permitting one of the one or more company approvers to check-out the proffered response from the approval pool for review;
(d) in the event the reviewing company approver approves the proffered response, returning the proffered response to the approval pool;
(e) determining whether all of the one or more company approvers have approved the proffered response;
(f) in the event that any of the one or more company approvers have not approved the proffered response, permitting a different one of the one or more company approvers to check-out the proffered response from the approval pool for review and returning to step (d); and
(g) in the event that all of the one or more company approvers have approved the proffered response, determining that the proffered response is approved.

6. The method for managing data requests over an electronic network received by a regulated entity of claim 5, wherein the method further comprises in the event that any one of the one or more company approvers objects to the proffered response, returning the proffered response to an administrator.

7. The method for managing data requests received by a regulated entity of claim 5, wherein the method further comprises overriding an assignment of the proffered response to one or more departments for approval.

8. The method for managing data requests received by a regulated entity of claim 1, wherein the electronic network is selected from the group consisting of a wired network, a wireless network, a local area network, a wide area network, a private network, a virtual private network, and the Internet.

9. A method for managing data requests over an electronic network received by a regulated entity comprising:
receiving an assignment of a data request;
preparing a draft proffered response to the data request;
submitting the draft proffered response to a reviewer;
receiving from the reviewer one or more comments to the draft proffered response; and
preparing a proffered response to the data request.

10. The method for managing data requests over an electronic network received by a regulated entity of claim 9, wherein the electronic network is selected from the group consisting of a wired network, a wireless network, a local area network, a wide area network, a private network, a virtual private network, and the Internet.

11. A method for managing data requests over an electronic network received by a regulated entity comprising:
entering a docket for a regulatory proceeding into a docket folder within a docket datastore;
associating with each docket folder one or more data requesters each having submitted one or more data requests in the regulatory proceeding;
associating with each data requestor the one or more data requests made by that party requestor; and
saving each data request made by each of the one or more party requestors in a data request folder within the docket datastore.

12. The method for managing data requests over an electronic network received by a regulated entity of claim 11, wherein the data request folder further comprises a response structure, and wherein the method further comprises:
selecting one of the one or more data requests from the data request folder;
designating in the response structure a selected company user selected from the user folder of the regulated entity to proffer a response to the selected data request; and
obtaining from the selected company user the proffered response to the selected data request.

13. The method for managing data requests over an electronic network received by a regulated entity of claim 12, wherein the method further comprises:
(a) assigning the proffered response to one or more departments for approval;
(b) submitting the proffered response to an approval pool;
(c) permitting one of the one or more assigned departments to check-out the proffered response from the approval pool for review;
(d) in the event the reviewing department approves the proffered response, returning the proffered response to the approval pool;
(e) determining whether all of the one or more assigned departments have approved the proffered response;
(f) in the event that any of the one or more assigned department have not approved the proffered response, permitting a different one of the one or more assigned departments to check-out the proffered response from the approval pool for review and returning to step (d); and
(g) in the event that all of the one or more assigned department have approved the proffered response, approving the response for publication to the requestor.

14. The method for managing data requests over an electronic network received by a regulated entity of claim 13, wherein the method further comprises in the event that any one of the one or more assigned departments objects to the proffered response, returning the proffered response to an administrator.

15. The method for managing data requests over an electronic network received by a regulated entity of claim 12, wherein the method further comprises:
(a) designating one or more selected company approvers to approve the proffered response;
(b) submitting the proffered response to an approval pool;
(c) permitting one of the one or more designated company approvers to check-out the proffered response from the approval pool for review;
(d) in the event the reviewing company approver approves the proffered response, returning the proffered response to the approval pool;
(e) determining whether all of the one or more designated company approvers have approved the proffered response;
(f) in the event that any of the one or more designated company approvers have not approved the proffered response, permitting a different one of the one or more designated company approvers to check-out the proffered response from the approval pool for review and returning to step (d); and
(g) in the event that all of the one or more designated company approvers have approved the proffered response, approving the response for publication to the requestor.

16. The method for managing data requests over an electronic network received by a regulated entity of claim 15, wherein the method further comprises in the event that any of the one or more designated company approvers objects to the proffered response, returning the proffered response to an administrator.

17. The method for managing data requests over an electronic network received by a regulated entity of claim 15, wherein the method further comprises overriding the assignment of the proffered response to one or more departments for approval.

18. The method for managing data requests over an electronic network received by a regulated entity of claim 11, wherein entering a docket for a regulatory proceeding into a docket folder within a docket datastore comprises:
selecting a regulatory proceeding type and a jurisdiction; and
populating the docket folder based on the specified regulatory proceeding type and the specified jurisdiction.

19. The method for managing data requests over an electronic network received by a regulated entity of claim 11, wherein entering a docket for a regulatory proceeding into a docket folder within a docket datastore comprises:
selecting a regulatory proceeding type and a jurisdiction; and
selecting a template for the proceeding type within the specified jurisdiction, wherein the template populates the docket folder.

20. The method for managing data requests over an electronic network received by a regulated entity of claim 11, wherein the electronic network is selected from the group consisting of a wired network, a wireless network, a local area network, a wide area network, a private network, a virtual private network, and the Internet.

21. A system for managing data requests received by a regulated entity comprising:
a datastore for receiving one or more data requests;
a data request management server, the data request management server connected to the datastore and adapted to respond to instructions to:
select a data request for response;
associate a data request with a company user for response;
receive a proffered response to the data request from the company user;
obtain approval of the proffered response from each of one or more approvers; and
provide an approved proffered response to a party from which the data request was received.

22. The system of claim 21, the system further comprising:
an electronic network; and
a network interface connected to the electronic network and to the data request management server, wherein the data request management server is accessible to one or more users via the network interface.

23. The system of claim 22, wherein the electronic network is selected from the group consisting of a wired network, a wireless network, a local area network, a wide area network, a private network, a virtual private network, and the Internet.

24. The system of claim 21, wherein the data request management server is further adapted to:
(a) respond to instructions to associate the proffered response with one or more departments for approval;
(b) respond to instructions to submit the proffered response to an approval pool;
(c) permit one of the one or more departmental approvers to check-out the proffered response from the approval pool for review;
(d) in the event the reviewing departmental approver approves the proffered response, return the proffered response to the approval pool;
(e) determine whether all of the one or more departmental approvers have approved the proffered response;
(f) in the event that any of the one or more departmental approvers have not approved the proffered response, permit a different one of the one or more departmental approvers to check-out the proffered response from the approval pool for review and returning to step (d); and
(g) in the event that all of the one or more departmental approvers have approved the proffered response, respond to instructions identifying the proffered response as approved.

25. The system of claim 24, wherein the data request management server is further adapted to, in the event that any one of the one or more company approvers objects to the proffered response, return the proffered response to an administrator.

26. The system of claim 21, wherein the data request management server is further adapted to:
(a) respond to instructions to designate one or more company approvers to approve the proffered response;
(b) respond to instructions to submit the proffered response to an approval pool;
(c) permit one of the one or more company approvers to check-out the proffered response from the approval pool for review;
(d) in the event the reviewing company approver approves the proffered response, return the proffered response to the approval pool;
(e) determine whether all of the one or more company approvers have approved the proffered response;
(f) in the event that any of the one or more company approvers have not approved the proffered response, permit a different one of the one or more company approvers to check-out the proffered response from the approval pool for review and returning to step (d); and
(g) in the event that all of the one or more company approvers have approved the proffered response, respond to instructions to identify the proffered response as approved.

27. The system of claim 26, wherein the data request management server is further adapted to, in the event that any one of the one or more company approvers objects to the proffered response, return the proffered response to an administrator.

28. The system of claim 21, wherein the data request management server is further adapted to override an assignment of the proffered response to one or more departments for approval.

29. A system for managing data requests received by a regulated entity comprising:
a docket datastore, the docket datastore comprising:
a docket folder associated with a regulatory proceeding, and wherein the docket folder comprises:
one or more data requesters each having submitted one or more data requests in the regulatory proceeding;
one or more data requests submitted by any of the one or more data requestors;
one or more users associated with each of the one or more data requestors; and
a data request management server, wherein the server is adapted to communicate with the docket datastore.

30. The system of claim 29, wherein the data request management server is further adapted to respond to instructions to create a set of user roles, and wherein each of the one or more users is assigned a user role.

31. The system of claim 30, wherein the user role assigned to each of the one of the more users determines a level of access of that user to the data request management server.

32. The system of claim 29, the system further comprising:
an electronic network; and
a network interface connected to the electronic network and to the data request management server, wherein the data request management server is accessible to one or more users via the network interface.

33. The system of claim 32, wherein the electronic network is selected from the group consisting of a wired network, a wireless network, a local area network, a wide area network, a private network, a virtual private network, and the Internet.

34. The system of claim 29, wherein the data request management server is further adapted to respond to instructions to:
select a data request for response;
associate the selected data request with a company user for response;
receive a proffered response to the selected data request from the company user;
obtain approval of the proffered response from each of one or more approvers; and
provide an approved proffered response to a party from which the data request was received.

35. The system of claim 29, wherein the data request management server is further adapted to:
(a) respond to instructions to associate the proffered response with one or more departments for approval;
(b) respond to instructions to submit the proffered response to an approval pool;
(c) permit one of the one or more departmental approvers to check-out the proffered response from the approval pool for review;
(d) in the event the reviewing departmental approver approves the proffered response, return the proffered response to the approval pool;
(e) determine whether all of the one or more departmental approvers have approved the proffered response;
(f) in the event that any of the one or more departmental approvers have not approved the proffered response, permit a different one of the one or more departmental approvers to check-out the proffered response from the approval pool for review and returning to step (d); and
(g) in the event that all of the one or more departmental approvers have approved the proffered response, respond to instructions identifying the proffered response as approved.

36. The system of claim 35, wherein the data request management server is further adapted to, in the event that any one of the one or more company approvers objects to the proffered response, return the proffered response to an administrator.

37. The system of claim 29, wherein the data request management server is further adapted to:
(a) respond to instructions to designate one or more company approvers to approve the proffered response;
(b) respond to instructions to submit the proffered response to an approval pool;
(c) permit one of the one or more company approvers to check-out the proffered response from the approval pool for review;
(d) in the event the reviewing company approver approves the proffered response, return the proffered response to the approval pool;
(e) determine whether all of the one or more company approvers have approved the proffered response;
(f) in the event that any of the one or more company approvers have not approved the proffered response, permit a different one of the one or more company approvers to check-out the proffered response from the approval pool for review and returning to step (d); and
(g) in the event that all of the one or more company approvers have approved the proffered response, respond to instructions to identify the proffered response as approved.

38. The system of claim 37, wherein the data request management server is further adapted to, in the event that any one of the one or more company approvers objects to the proffered response, return the proffered response to an administrator.

39. The system of claim 29, wherein the data request management server is further adapted to override an assignment of the proffered response to one or more departments for approval.

40. The system of claim 29, wherein the data request management server is further adapted to:
upon creation of a new docket within the docket datastore, request a docket jurisdiction and a proceeding type; and
in the event that the docket jurisdiction and proceeding type are provided, populate the docket folder.

41. The system of claim 29, wherein the data request management server is further adapted to:
respond to instructions to select a docket template; and
populate docket folder based on the content of the docket template.
